(19) United States
(12) Patent Application Publication
(10) Pub. No.: US 2004/0057808 A1
(43) Pub. Date: Mar. 25, 2004

(54) Device for transporting, handling and storing tubular goods

(76) Inventor: Victor J. Segura, New Iberia, LA (US)

Correspondence Address: Ted M. Anthony, Perret Doise, Post Office Drawer 3408, Lafayette, LA, 70502, US

(21) Appl. No.: 10/255,459

(22) Filed: Sep. 25, 2002

(51) Int. Cl. B60P 7/12

(52) U.S. Cl. 410/42

(57) ABSTRACT

A device which can be used in connection with the transportation, handling and storage of pipe and other tubular goods. Such tubular goods are loaded into cradle members which support both ends of such tubular goods. Cables, slings or the like can be used to connect the cradle members to a crane or other lifting means. The cradle members can be vertically stacked, even when loaded with tubular goods.

### CROSS REFERENCES TO RELATED APPLICATIONS: NONE

### STATEMENTS AS TO RIGHTS TO INVENTIONS MADE UNDER FEDERALLY SPONSORED RESEARCH AND DEVELOPMENT: NONE

### INVENTOR: VICTOR JOSEPH SEGURA

### BACKGROUND OF THE INVENTION

1. Field of the Invention

The present invention relates to a device which can be used in connection with the storage, handling and/or transportation of pipe and other tubular goods. More particularly, the present invention relates to a device for the storage, handling and/or transportation of tubular goods which is fully adjustable to accommodate many different sizes and lengths of such tubular goods. More particularly still, the present invention relates to a device which can be used for the storage, handling and/or transportation of tubular goods in connection with numerous land-based and marine applications, including without limitation use on boats and offshore oil rigs.

2. Description of the Related Art

The storage and transportation of elongated cylindrical items, such as tubular goods, pipe and the like, has long presented challenges. These challenges, which exist in many different settings, are especially acute with respect to the oil and gas industry, and particularly offshore oil and gas operations. In such instances, large amounts of tubular goods must typically be transported from shore to marine locations such as offshore drilling rigs or production platforms.

In the oil and gas industry, tubular goods, such as casing, drill pipe and production tubing, are typically segmented into individual sections called “joints.” Each joint generally ranges in length from 30 to 40 feet, depending upon the type and diameter of the particular pipe in question. During the drilling phase, most oil and/or gas wells utilize multiple strings of drill pipe. Similarly, during the production phase, most wells are equipped with multiple strings of casing as well as production tubing. In the case of offshore wells, drill pipe, casing and tubing must all be transported from a land-based pipe yard or similar facility to a desired marine location via work boats or barges. Furthermore, the deeper a particular well, the greater the length of pipe needed and, accordingly, the more joints of pipe which ultimately must be transported to a given well location.

As existing oil and gas reservoirs become mature and depleted, the drilling of oil and/or gas wells occurs in ever more extreme environments. The design parameters of such wells can often require several different types and/or sizes of tubular goods. As such, there is frequently a need to transport many different sizes and types of tubular goods to a particular work location, especially in the case of wells drilled in such extreme environments. In such cases, large amounts of tubular goods must typically be delivered to such work destinations.

For reasons which are readily apparent, it is generally beneficial to transport tubular goods as efficiently as possible. This is true in both land and marine applications. It is also frequently advantageous to keep different sizes of tubular goods segregated from one another during the unloading process once a shipment of tubular goods has reached its ultimate destination.

In marine applications such as offshore environments, bundles of tubular goods are generally transported to a work site via a work boat or other marine vessel. Once the vessel reaches the site, the tubular goods are typically unloaded from the boat to the rig or platform using a crane. Under such circumstances, it is generally advantageous to keep the different sizes and types of tubular goods separated and/or segregated from one another to make the unloading operation more efficient, and to facilitate efficient use of said tubular goods in the operation at hand at the work site.

During the marine transportation of tubular goods, such tubular goods are typically laid out horizontally on the deck of a boat. Under such circumstances, it is generally desirable to keep such tubular goods contained and/or secured in place on such deck. Rough seas can cause boats to rock, which in turn can cause tubular goods on the decks of said boats to roll around. Because such tubular goods can be very heavy, rolling pipe can present a safety hazard to boats and personnel situated thereon. Accordingly, it is important to keep such tubular goods stationary and in a fixed position.

Devices known as “bolsters” have been developed for this purpose. However, such bolsters are often bulky, heavy, and difficult to load and unload. Alternatively, pipe racks or other similar means are frequently used on boats to keep tubular goods secure during the transportation process. Pipe racks are often also used on offshore facilities to accommodate the storage and handling of tubular goods after they have been offloaded from boats or other transportation vessels. However, such pipe racks can also be bulky and difficult to adjust to different sizes or types of pipes.

Once a boat carrying tubular goods arrives at an offshore rig or platform, bundles of tubular goods are typically lifted from the deck of the boat and on to the waiting facility. Such tubular goods are frequently placed on to a pipe rack or other storage area using a crane which is mounted on said rig. Frequently, bundles of pipe are held together and lifted from a transportation vessel using cables, slings, ropes or the like which are wrapped around such bundles in a direction which is generally perpendicular to the longitudinal axis of such tubular goods. In essence, a cable, sling or rope is looped transversely around a bundle of tubular goods.

This method of handling and transporting tubular goods can lead to serious safety problems because such tubular goods, which are often very heavy, can shift unexpectedly and without warning within the loops formed by such cables, slings or ropes. When this occurs, it is possible for one or more tubes to fall out of a bundle. Obviously, if this occurs when a bundle of pipe is suspended from a crane, one or more heavy joints of pipe can fall on to workers below, having disastrous consequences. Moreover, handling and transporting of tubular goods in this manner is frequently highly labor intensive, since workers must wrap and unwrap each bundle of pipe which is being loaded or unloaded. The chances for an accident or injury are often great, because such workers must frequently climb on, over and/or around such heavy tubular goods in order to manipulate cables or other bundling means.

Thus, it is desirable to have a device for the handling, transportation and storage of tubular goods which eliminates many of the safety problems associated with conventional methods of bundling tubular goods using cables, ropes, slings or the like. Further, it is desirable to have a device which makes such handling, transportation and storage of tubular goods more efficient than existing means of accomplishing these tasks.

### SUMMARY OF THE INVENTION

The present invention provides a device which can be used to transport, handle and/or store tubular goods such as drill pipe, casing, tubing and the like. The invention can accommodate virtually any size tubular goods (both in terms of length and diameter of such tubular goods). Further, the invention eliminates the need for bundling of tubular goods using cables, ropes, slings or other similar means, thereby eliminating the safety problems associated with this practice.

The present invention also permits efficient loading and unloading of tubular goods in connection with boats, trucks and/or other means of transportation. Moreover, the present invention eliminates the need for pipe racks or tubing bolsters on boats, trucks or rail cars, as well as on drilling rigs and other work sites or facilities. The present invention is also stackable, thereby reducing space requirements. This is particularly important in marine operations such as offshore drilling rigs and production platforms where available space is frequently very limited.

The present invention comprises two identical cradle members. Said cradle members are placed in opposing positions relative to one another, and spaced apart at roughly the same distance as the length of the tubular goods to be transported using the device. Tubular goods such as drill pipe, casing or the like are then loaded into said cradle members; one end of each tube or pipe is received within one cradle member, while the opposite end of said tube or pipe is received within the other cradle member.

Connection means are provided on each cradle member. Slings, cables or the like can be attached directly to said cradle members to permit lifting via crane or other hoisting means. Said connection means can be pad-eyes or other similar structures. However, in the preferred embodiment, said connection means are integral components of said cradle means, thereby eliminating the need for such pad-eyes.

In the preferred embodiment, the cradle members of the present invention are stackable. As such, one cradle member can be vertically positioned on another cradle member such that both cradle members remain stable and do not wobble or tip over. When loaded with tubular goods, said cradle members can be stacked to allow efficient storage of said tubular goods, such as on a boat deck or rig pipe rack. Similarly, even when not loaded with tubular goods, said empty cradle members can be easily stacked to promote efficient transportation from one location to another.

### BRIEF DESCRIPTION OF THE DRAWINGS

FIG. 1 depicts a side view of a boat loaded with tubular goods approaching an offshore platform (prior art).

FIG. 2 depicts a detailed side view of a boat loaded with tubular goods (prior art).

FIG. 3 depicts a bundle of pipe wrapped with cables (prior art).

FIG. 4 depicts a side view of tubular goods being off-loaded from a boat to an offshore structure using the device of the present invention.

FIG. 5 depicts a side view of a cradle member of the present invention.

FIG. 6 depicts a front view of a single cradle member of the present invention.

FIG. 7 depicts a perspective view of a single cradle member of the present invention.

FIG. 8 depicts a side view of the present invention loaded with tubular goods.

### DESCRIPTION OF THE PREFERRED EMBODIMENT

The present invention provides a device which can be used to transport, handle or store tubular goods in an efficient manner, while eliminating many of the safety concerns associated with existing methods of performing such tasks.

Initially, it should be noted that the device of the present invention can be utilized in connection with any number of different applications involving the use of elongate members, such as rods, tubes, pipes or the like. For illustration purposes, oil and gas operations in marine environments will be primarily discussed herein. However, nothing herein is intended to limit or otherwise restrict the present invention to only such oil and gas operations or marine applications. For example, the present invention could be used in connection with many different applications including, without limitation, road and/or rail transportation of elongate items.

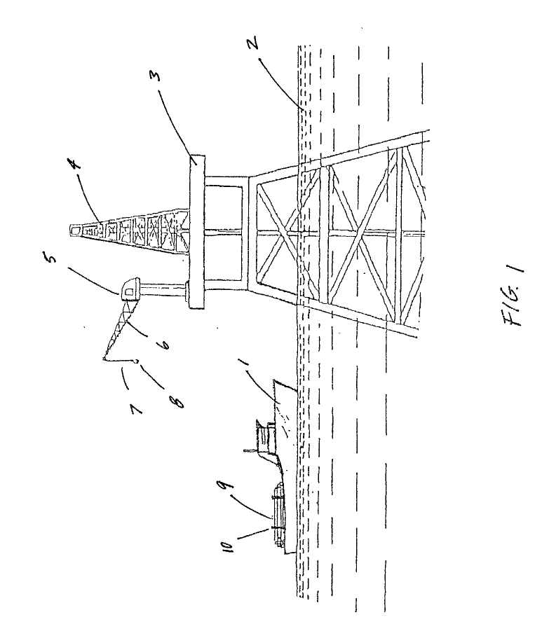

Referring to FIG. 1, a boat loaded with tubular goods is depicted generally approaching an offshore platform equipped with a drilling rig. FIG. 1 depicts boat 1 on the surface of water 2 approaching offshore platform 3. Drilling rig derrick 4 is positioned on the upper portion of platform 3. Similarly, crane 5 is also situated on the upper portion of platform 3. Crane boom 6 is shown extending over surface of water 2 to permit the transfer of supplies to and/or from boat 1 using crane line 7 and crane hook 8. Tubular goods 9 are depicted loaded on the deck of boat 1. Said tubular goods 9 are laid out horizontally on the deck of boat 1, and secured in place using pipe-rack 10.

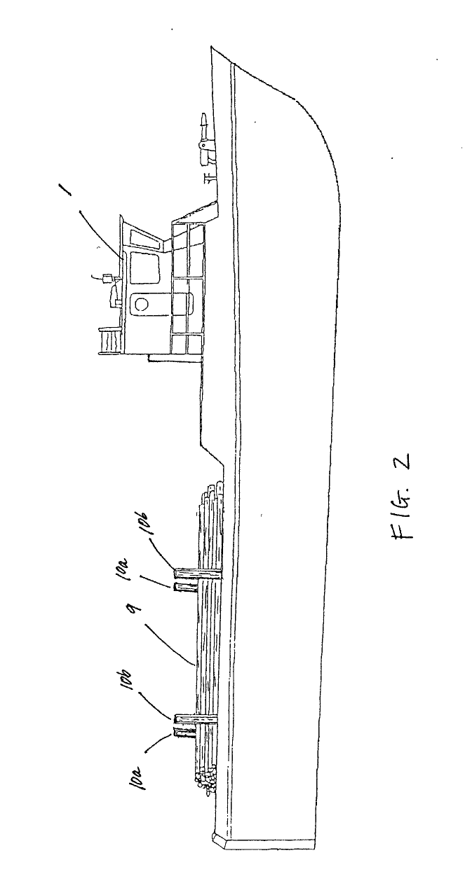

FIG. 2 depicts a detailed view of boat 1 employing a pipe rack which is well known in the prior art. Tubular goods 9, which can be drill pipe, casing, production tubing or the like, are loaded within vertical members 10a and 10b of pipe rack 10 on the deck of boat 1. Said tubular goods are situated horizontally on the deck of boat 1, and are generally kept from rolling or shifting on such deck by vertical pipe-rack members 10a and 10b.

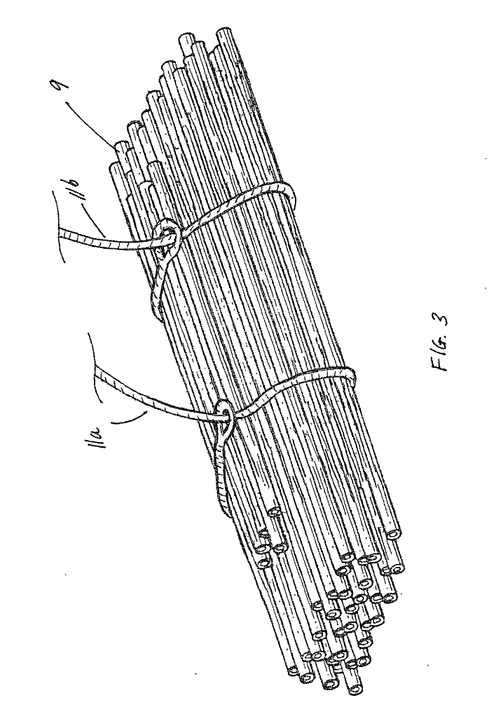

FIG. 3 depicts a method of lifting tubular goods 9 which is well known in the prior art. Cables 11a and 11b are looped around a collection of tubular goods 9 so as to form a bundle. Typically, said cables 11a and 11b are looped around the outer surface of said tubular goods in a direction which is substantially perpendicular to the longitudinal axis of tubular goods 9. The opposite ends of said cables 11a and 11b are then typically attached to a crane or other hoisting means, such as crane 5 shown in FIG. 1.

Numerous problems can occur when manipulating tubular goods according to the method depicted in FIG. 3. Generally, workers are required to climb over, under and/or around said tubular goods on the deck of a boat in order to wrap or loop cables 11a and 11b around the outer surface of said tubular goods. This can be very labor intensive. Moreover, said workers are often required to be in awkward positions, and are often at great risk of having their hands, feet, or other body parts pinched or crushed between said tubular goods which are often very heavy and difficult to control. This is especially true on boats, where wave motion can rock the boat and cause tubular goods on the deck of the boat to shift unexpectedly even within pipe racks.

The bundling of tubular goods according to the prior art as depicted in FIG. 3 also does not ensure that firm control is maintained on said tubular goods. For example, if said tubular goods are not tightly packed together in a bundle, it is possible that said tubular goods may shift within the loops formed by cables 11a and 11b. Unless such loops formed by cables 11a and 11b fully constrict around said tubular goods, said cables may not have a firm grip around such tubular goods. This can be especially problematic during lifting operations. If cables 11a and/or 11b are not tightly wrapped around said tubular goods, one or more of the pipes can fall out of the loops formed by such cables, resulting in a serious risk of personal injury or damage to property caused by such falling pipe.

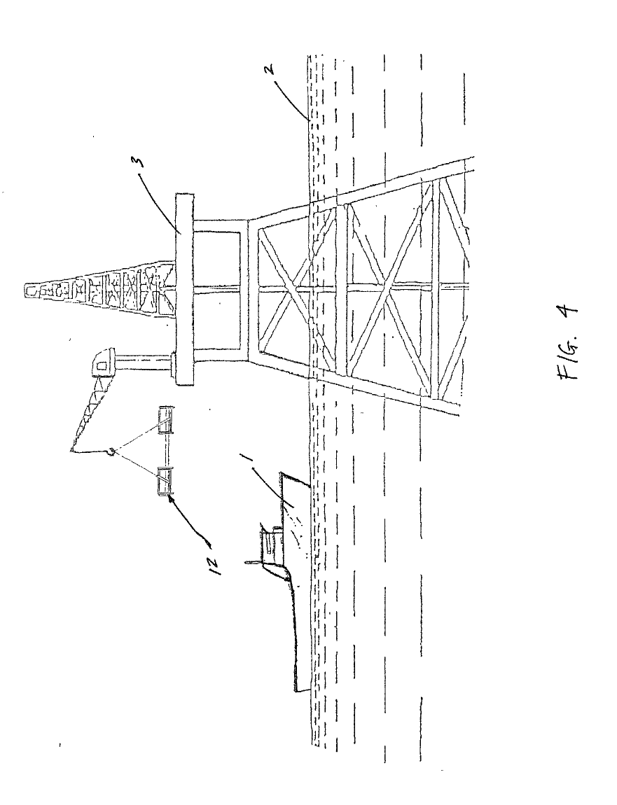

FIG. 4 depicts a side view of tubular goods being off-loaded from boat 1 to offshore platform 3 using the device of the present invention 12. As described in more detail in subsequent drawings, the present invention permits safe and efficient transportation, handling and storage of tubular goods, while eliminating many of the safety problems associated with conventional methods of performing such tasks.

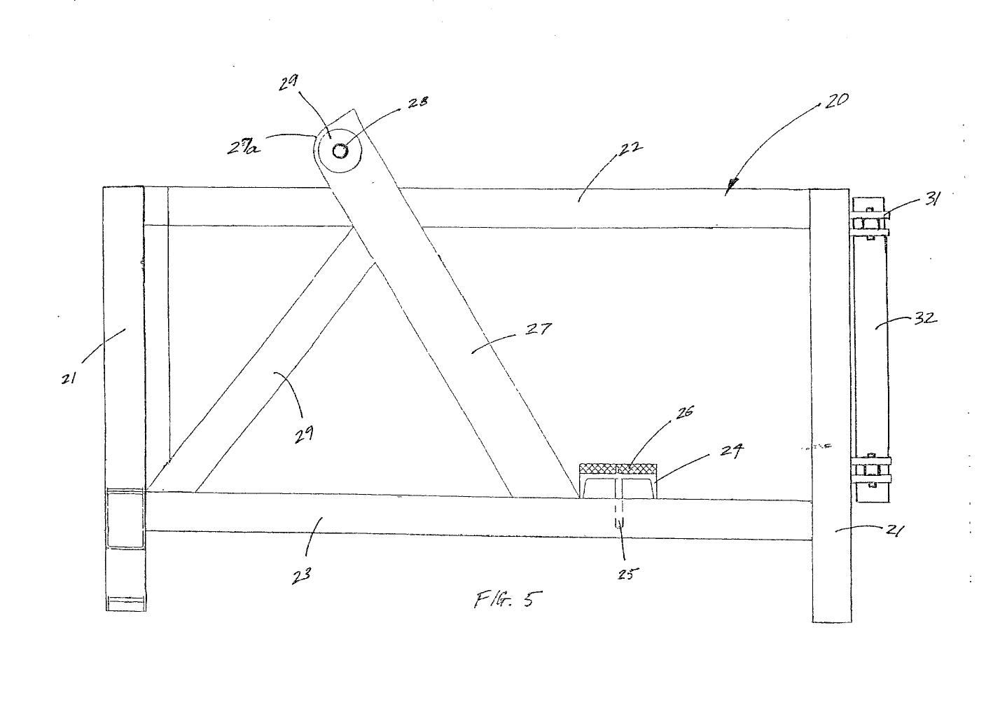

FIG. 5 depicts a side view of a cradle member 20 of the present invention. In the preferred embodiment, said cradle member 20 is generally comprised of vertical corner posts 21. Upper horizontal member 22 extends between said vertical corner posts 21. Similarly, lower horizontal base 23 extends between said vertical corner posts 21. In the preferred embodiment, lower horizontal base 23 is raised a desired distance above the bottom of vertical corner posts 21 and provides a substantially planar surface. Raised pedestal 24 extends above said lower horizontal base and is anchored thereto using anchoring member 25. Wood piece 26 is disposed on the upper surface of raised pedestal 24.

Structural lift member 27 extends from horizontal base 23 and beyond horizontal upper member 22. Bore 28 extends through structural lift member 27. Reinforcement plates 29 are located on the outer surfaces of structural member 27 around bore 28. Although it is possible that structural lift member 27 can be in any number of configurations, in the preferred embodiment said member is positioned so that the angle formed between horizontal base 23 and structural lift member 27 is approximately sixty (60) degrees. Upper surface 27a of structural lift member 27 has a convex outer configuration. Opposing structural member 30 extends diagonally from horizontal base 23 to structural lift member 27 to provide support therefor.

In the preferred embodiment, hinge members 31 extend from vertical corner posts 21 along the rear of cradle member 20. Rear gate member 32 is swingably disposed within hinge members 31, and can be opened to provide access to the inside of cradle member 20. Alternatively, rear gate member 32 can be completely removed to permit access to the inside of cradle member 20.

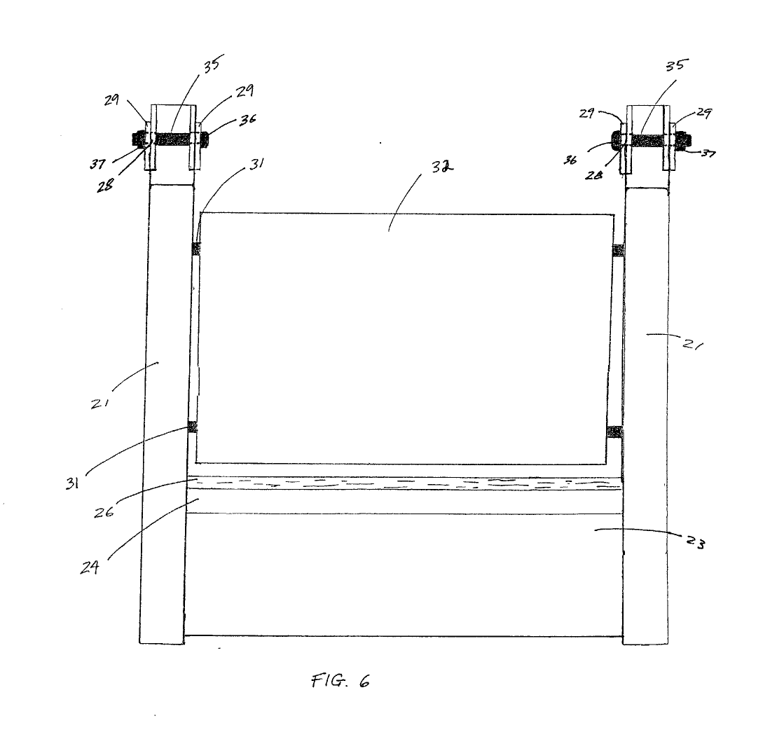

FIG. 6 depicts a front view of a cradle member 20 of the present invention. In the preferred embodiment, vertical corner posts 21 are situated near the front end of said cradle member. Lower horizontal base 23 extends between said vertical corner posts 21. In the preferred embodiment, lower horizontal base 23 is raised a desired distance above the bottom of vertical corner posts 21. Lower horizontal base 23 provides a substantially planar surface. Raised pedestal 24 extends above said lower horizontal base and is anchored thereto. Wood piece 26 is disposed on the upper surface of raised pedestal 24.

Structural lift members 27 extend above the top of vertical corner posts 21 and horizontal upper members 22 (not shown on FIG. 6). Bores 28 extend through structural lift member 27. Reinforcement plates 29 are located on the outer surfaces of structural members 27 at bores 28. Bolts 35 are disposed within bores 28. In the preferred embodiment, bolts 35 are made of hardened steel or other reinforced material. Said bolts 35 are held in place within bores 28 by virtue of enlarged bolt heads 36 and nuts 37 which are threadably connected onto bolts 35.

Rear gate member 32 is disposed along the back side of cradle member 20 using hinge members 31. Rear gate member 32 is swingably attached and can be opened, or completely removed, to provide access to the inside of cradle member 20.

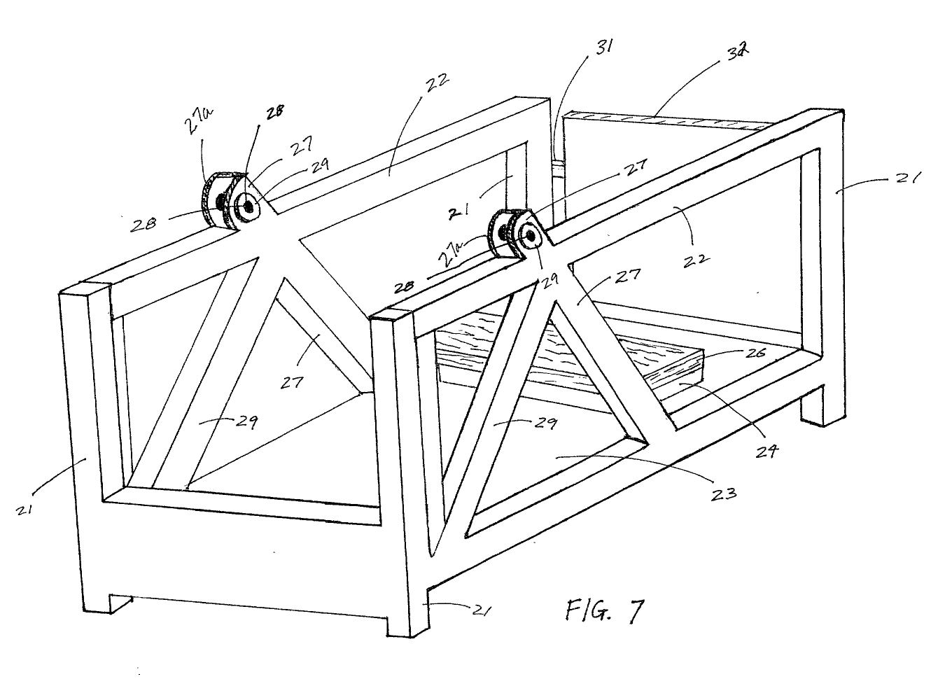

FIG. 7 depicts a perspective view of a cradle member 20 of the present invention. In the preferred embodiment, said cradle member 20 is generally comprised of vertical corner posts 21. Upper horizontal members 22 extend between said vertical corner posts 21. Similarly, lower horizontal base 23 extends between said vertical corner posts 21. In the preferred embodiment, lower horizontal base 23 is raised a desired distance above the bottom of vertical corner posts 21, and provides a substantially planar surface. Raised pedestal 24 extends above said lower horizontal base and is anchored thereto. Wood piece 26 is disposed on the upper surface of raised pedestal 24.

Structural lift members 27 extend from horizontal base 23 through horizontal upper members 22. Bores 28 extend through structural lift members 27. Reinforcement plates 29 are located on the outer surfaces of structural members 27, surrounding and reinforcing bores 28. Although it is possible that structural lift members 27 can be in any number of configurations, in the preferred embodiment said members are positioned so that the angle formed between horizontal base 23 and structural lift members 27 is approximately sixty (60) degrees. Upper surface 27a of structural lift members 27 exhibit a convex outer configuration. Opposing structural members 30 extend diagonally from horizontal base 23 to structural lift members 27 to provide structural support therefor.

In the preferred embodiment, hinge members 31 extend from vertical corner posts 21 along the rear of cradle member 20. Rear gate member 32 is disposed along the back side of cradle member 20 via hinge members 31. Rear gate member 32 is swingably attached and can be opened or entirely removed to provide access to the inside of cradle member 20.

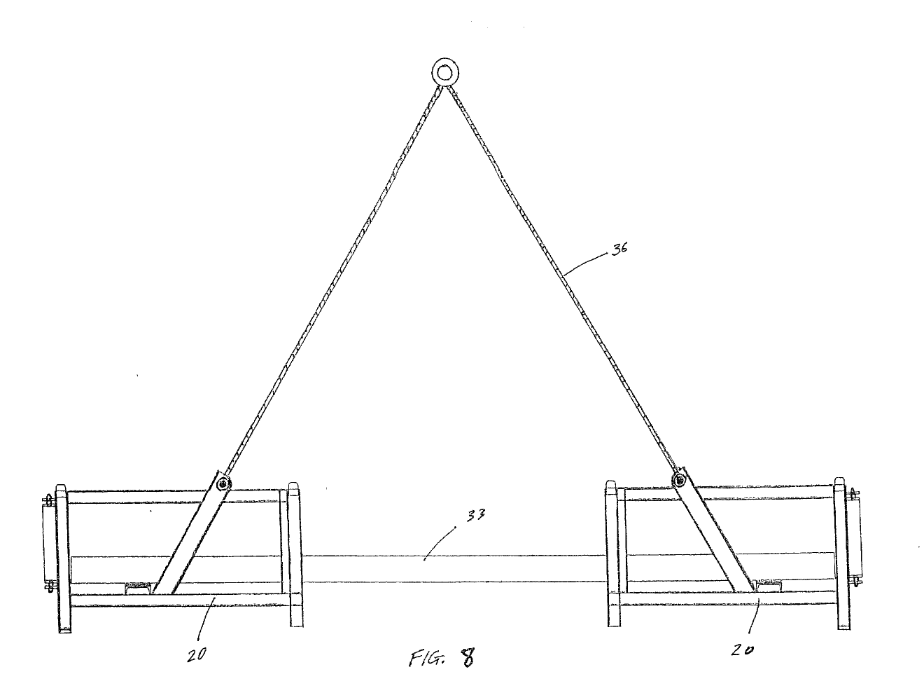

FIG. 8 depicts a side view of the present invention loaded with tubular goods. Cradle members 20 are positioned opposite one another. Said cradle members 20 are identical to one another; however, they are placed in opposing relation facing each other. Said cradle members are spaced apart at a distance which is roughly equivalent to the length of the tubular goods to be loaded within the device of the present invention. Tubular goods 33 are disposed within said opposing cradle members 20. Said tubular members 33 rest upon wood pieces 26 on pedestals 24 in order to prevent scarring or damage to the outer surfaces of said tubular goods.

Cables of slings 34 connect to cradle members 20 of the present invention. In the preferred embodiment, bolts 35 are received within bores 28 in structural lift members 27 of cradle members 20. Said bolts are also threaded through loops or shackles at the lower end of slings 34. Convex upper surfaces 27a of structural lift members 27 permit free range of motion for said slings. A crane or other lifting device can be attached to sling loop 36 in order to lift the device of the present invention.

Although preferred embodiments of the subject invention have been described herein, it should be understood that various changes, adaptations and modifications may be made therein without departing from the spirit of the invention and the scope of the appended claims.

What is claimed is:

1. An apparatus for holding elongate objects comprising:
a. a first cradle member for receiving one end of said elongate objects;
b. a second cradle member for receiving the opposite end of said elongate objects; and
c. at least one flexible member attached to said first and second cradle members.
